(19) United States
(12) Patent Application Publication
(10) Pub. No.: US 2024/0107416 A1
(43) Pub. Date: Mar. 28, 2024

(54) RELAY UE ADMISSION AND CELL CHANGE WHEN PROTOCOL STATE IS IDLE OR INACTIVE

(71) Applicant: MEDIA TEK INC., Hsinchu (TW)

(72) Inventors: Nathan Edward Tenny, San Jose, CA (US); Xuelong Wang, Beijing (CN); Ming-Yuan Cheng, Hsinchu (TW)

(21) Appl. No.: 18/369,511

(22) Filed: Sep. 18, 2023

(30) Foreign Application Priority Data
Sep. 27, 2022 (WO) PCT/CN2022/121703
Oct. 8, 2022 (WO) PCT/CN2022/123817
Sep. 7, 2023 (CN) 202311152440.4

(51) Int. Cl. H04W 36/36; H04W 36/00

(52) U.S. Cl. CPC H04W 36/36; H04W 36/0061; H04W 36/0079; H04W 88/04

(57) ABSTRACT

In an aspect of the disclosure, a method, a computer-readable medium, and an apparatus are provided. The apparatus may be a first UE. In certain configurations, the first UE operates in an idle or inactive protocol state in a service of a first cell and performs a discovery procedure with a second UE, wherein the discovery procedure includes indicating, to the second UE, an identity of the first cell. The first UE further performs a cell reselection procedure to a second cell, receives, from the second UE, subsequent to the performing the cell reselection procedure, a message for forwarding to the first cell, and sends, to the second UE, a notification message, wherein the notification message includes an indication of an inability to forward the message.

### CROSS-REFERENCE TO RELATED APPLICATION(S)

This application claims the benefit of PCT Application Number CN2022/121703, entitled “RELAY UE SELECTION AND ADMISSION” and filed on Sep. 27, 2022 and PCT Application Number CN2022/123817, entitled “CELL CHANGE HANDLING BY RELAY UE IN AN IDLE OR INACTIVE PROTOCOL STATE” and filed on Oct. 8, 2022, both of which are expressly incorporated by reference herein in their entireties.

### BACKGROUND

### Field

The present disclosure relates generally to communication systems, and more particularly, to techniques of handling cell change during a path switch operation by a remote UE to the service of a target relay UE and techniques for admitting to connected-mode operation a relay UE in a serving cell when a remote UE switches a communication path to use the relay UE, wherein, for both techniques, the target relay UE is in an idle or inactive state of a protocol.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first user equipment (UE). In certain configurations, the first UE operates in an idle or inactive protocol state in a service of a first cell and performs a discovery procedure with a second UE, wherein the discovery procedure includes indicating, to the second UE, an identity of the first cell. The first UE further performs a cell reselection procedure to a second cell, receives, from the second UE, subsequent to the performing the cell reselection procedure, a message for forwarding to the first cell, and sends, to the second UE, a notification message, wherein the notification message includes an indication of an inability to forward the message.

In certain configurations, the first cell can be operated by a first base station and the second cell can be operated by a second base station, the first base station and the second base station being different.

In certain configurations, the notification message can include an indication that the first UE has performed a cell reselection. In certain configurations, the notification message can include an indication that the first UE cannot operate as a relay UE in the second cell.

In certain configurations, the message for forwarding to the first cell can be a handover completion message for completing a handover, wherein the handover completion message can be intended to be forwarded to the first cell. The method can further include storing, at the time of the discovery procedure, an identity of the first cell or an identity of a first base station operating the first cell, comparing, at the time of receiving the message for forwarding, the stored identity to an identity of the second cell that is currently serving the first UE or an identity of a second base station operating the second cell, and determining that the first UE is unable to forward the message for forwarding based on a result of the comparison.

In another aspect of the disclosure, a method, a computer-readable medium, and an apparatus are provided. The apparatus may be a first UE. In certain configurations, the first UE performs a discovery procedure with a second UE, wherein the discovery procedure includes receiving, from the second UE, an identity of a serving cell of the second UE. The first UE further receives, from a base station operating a serving cell of the first UE, a reconfiguration message, wherein the reconfiguration message includes a handover command. The first UE further establishes a communication link with the second UE, sends, to the second UE, a handover completion message, and receives, from the second UE, a notification message. The notification message includes an indication of an inability of the second UE to forward the handover completion message. The first UE further initiates a failure handling procedure.

In certain configurations, the receiving the reconfiguration message can include receiving, from a third UE served by the base station, the reconfiguration message. In certain configurations, the notification message can include an indication that the second UE has performed a cell reselection. In certain configurations, the notification message can include an indication that the second UE cannot operate as a relay UE in a cell that is currently serving the second UE. In certain configurations, the failure handling procedure includes one or more of a relay reselection procedure, a cell reselection procedure, and a connection re-establishment procedure.

In another aspect of the disclosure, a method, a computer-readable medium, and an apparatus are provided. The apparatus may be a first UE. In certain configurations, the first UE receives, during one or more discovery procedures between the first UE and at least one second UE, information about an interface between the at least one second UE and a second network node. The first UE further transmits, to a first network node, a measurement report message comprising the measurement and the information.

In certain configurations, the information can include an indication of radio quality on the interface. In certain configurations, the indication can be a measurement of at least one of reference signal received power (RSRP) and reference signal received quality (RSRQ). In certain configurations, the indication can be a threshold of link quality. In certain configurations, the indication can be a measure of anticipated link performance. In certain configurations, the information can include an indication of at least one supported communication capability on the interface.

In certain configurations, the capability can be at least one of a supported CA capability and a supported MIMO capability. In certain configurations, the information can include an indication of a protocol state in which the first UE operates on the interface. In certain configurations, during the discovery procedure, the at least one second UE can be operating in an idle or inactive protocol state in a service of a cell established by the second network node. In certain configurations, the measurement report message can be transmitted in preparation for a handover procedure between the first network node and the second network node for one of the at least one second UEs to function as a relay UE for the first UE to allow the second network node to service the first UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a schematic diagram of a communication system illustrating example relay and remote UE operation.

FIG. 8 is a schematic diagram of a communication system illustrating an example path switch procedure.

FIG. 9 is a schematic diagram of a communication system illustrating a second example path switch procedure.

FIG. 10 is a message flow diagram illustrating an example direct-to-indirect path switch procedure.

FIG. 11 is a message flow diagram for an example direct-to-indirect path switch procedure in which a target relay UE is initially in an idle or inactive protocol state when it reselects to a new cell during the path switch procedure.

FIG. 12 is a flow diagram showing an example path switch procedure in which a target relay UE is initially in an idle/inactive state.

FIG. 13 is a flow chart of a method (process) for cell reselection handling.

FIG. 14 is a flow chart of a method (process) for path switch control.

FIG. 15 is a flow chart of a method (process) for measurement reporting.

FIG. 16 is a diagram illustrating an example of a hardware implementation for an apparatus employing a processing system.

FIG. 17 is a diagram illustrating an example of a hardware implementation for another apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

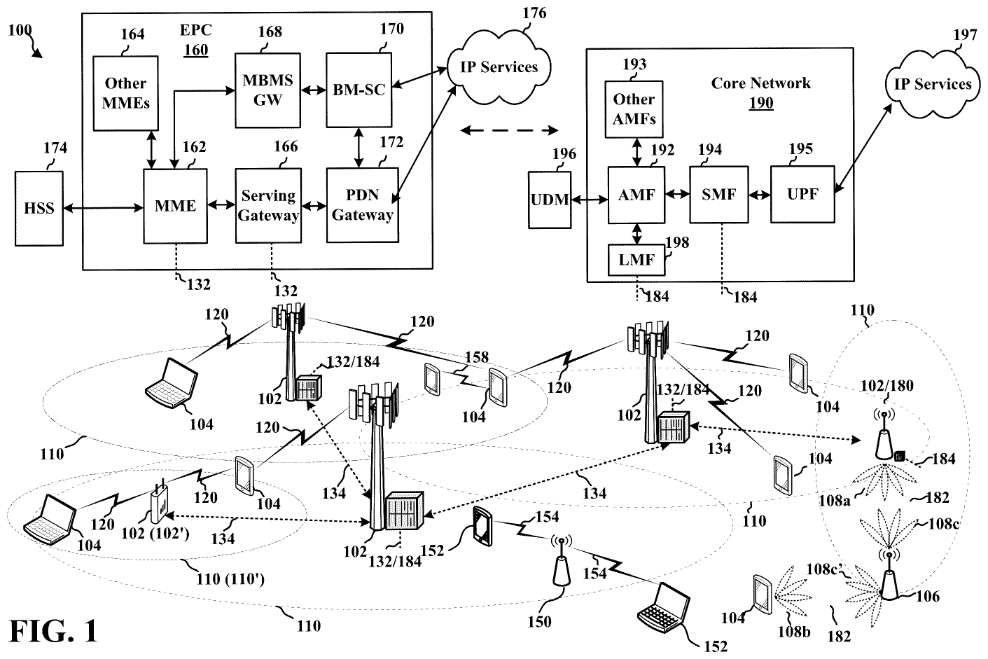

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

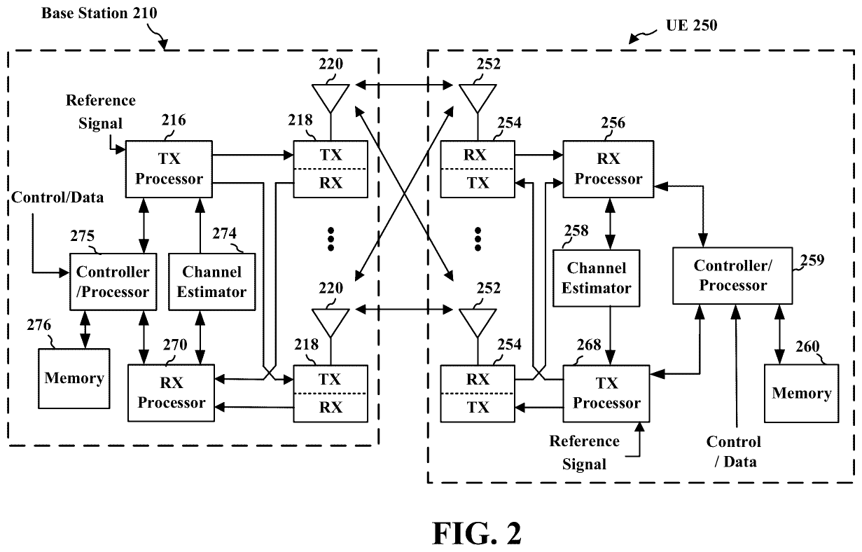

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

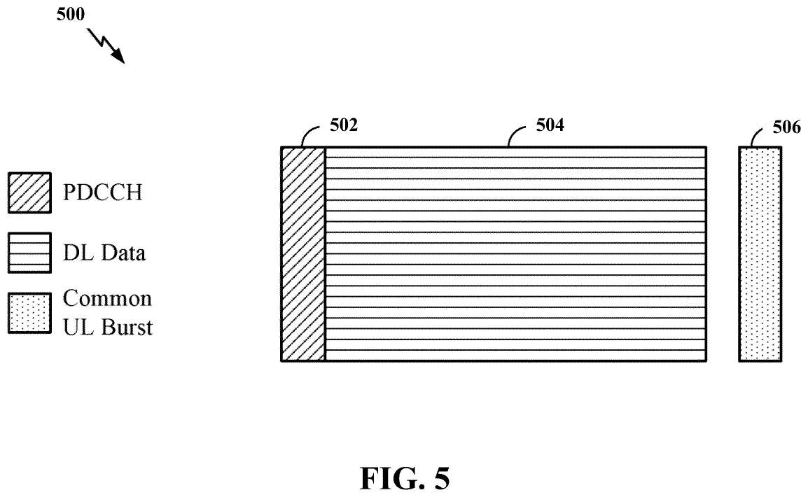

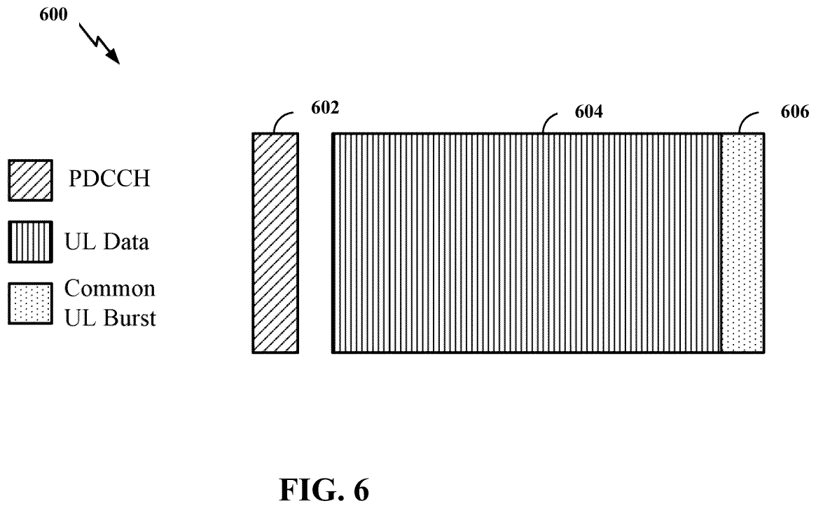

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

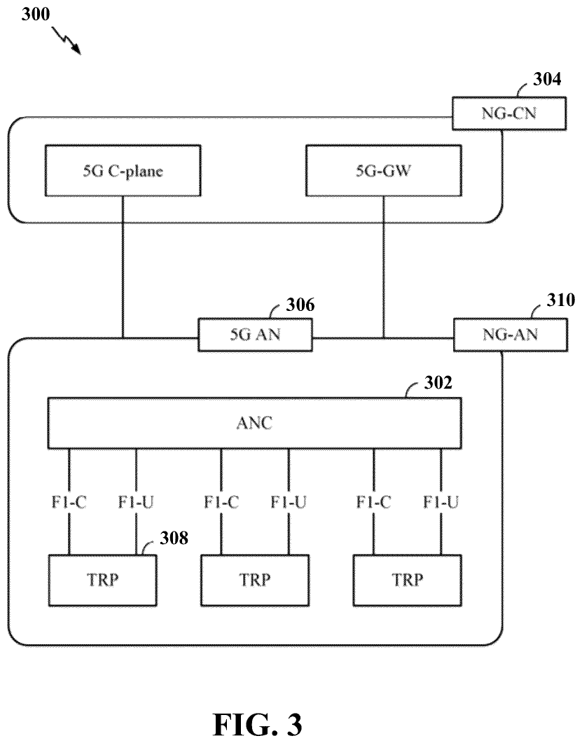

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

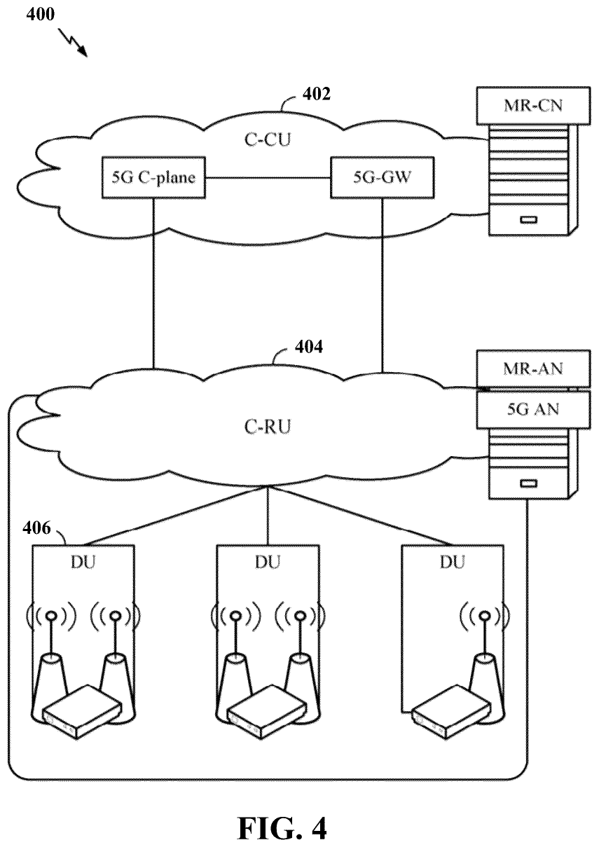

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

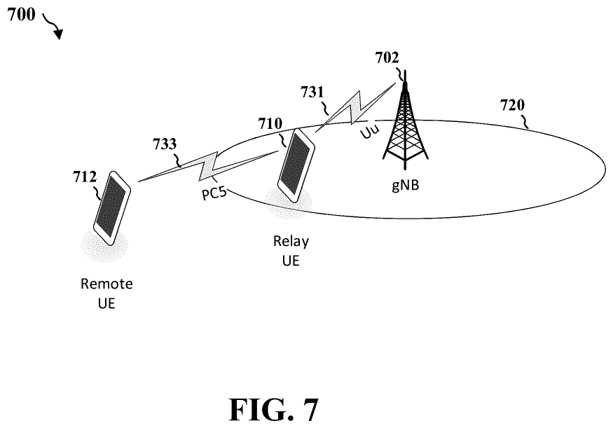

With reference to FIGS. 7-10, diagrams illustrating path switch procedures are shown, with the aim of illustrating challenges that can arise in certain contexts. In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In certain wireless systems, such as 3GPP 5G New Radio (NR) from Rel-17 onward, a first user equipment (UE) may function in a relaying relationship with a second UE. For example, the first UE may be out of direct cellular coverage or in poor coverage, while the second UE is in good coverage, and the second UE may deliver communications between the first UE and the serving cellular network. In this scenario, the first UE may be referred to as a remote UE and the second UE may be referred to as a relay UE. The remote UE may be referred to as being in “indirect service” or having an “indirect path” to the network, while the relay UE may be referred to as being in “direct service” or having a “direct path” to the network. The relay and remote UEs may communicate via a sidelink interface, also called a PC5 interface, in which radio resources are used for direct communication between UEs without an intervening network node. Other interfaces between the relay and remote UEs may be contemplated, such as wired or wireless technologies (for example, WiFi communication), proprietary connections, and so on.

Due to change of radio conditions, physical mobility of the remote and/or relay UEs, and similar considerations, a remote UE may need to switch its service from one path to another—for example, from a direct path to an indirect path, or from an indirect path via a first relay UE to an indirect path via a second relay UE (both of which are referred to as a “path switch” or an “x2i path switch”). (Path switch from an indirect path to a direct path is also possible, but it is outside the scope of this disclosure.) The remote UE's serving cell and/or serving base station (e.g., gNB) before such a path switch need not be the same as the remote UE's serving cell and/or serving base station after the path switch; for example, a remote UE may move from direct service with a cell operated by a first (source) gNB to indirect service via a (target) relay UE with a cell operated by a second (target) gNB, or from indirect service via a first (source) relay UE with a cell of a first (source) gNB to indirect service via a second (target) relay UE with a cell of a second (target) gNB. Such an inter-gNB path switch may be facilitated by a handover procedure, in which a handover command is generated by the target gNB and passed via the source gNB to the remote UE, and the remote UE responds with a handover complete message via the target relay UE to the target gNB.

The target relay UE may be in a variety of protocol states, such as an RRC_CONNECTED state, an RRC_INACTIVE state, or an RRC_IDLE state of a radio resource control (RRC) protocol. In an RRC_CONNECTED protocol state, the target relay UE has an RRC connection with the target gNB, and its cell mobility is under the control of the target gNB. When the target relay UE is in an RRC_INACTIVE state or an RRC_IDLE state (referred to as idle/inactive), different challenges can arise.

For example, in a first path-switch scenario, when the target relay UE is in an idle/inactive state, the target relay UE controls its own cell mobility and can reselect to a new cell (potentially operated by a gNB different from the target gNB, referred to as a new gNB) while a path switch is in progress. In such a case, problems arise due to the remote UE being unaware that a reconfiguration complete message cannot be processed properly, causing the handover to fail. The reconfiguration complete message has the function of a handover complete message, namely to add a target gNB and release the source gNB. The terms “reconfiguration complete message” and “handover complete message” are used interchangeably. In the network context, the new gNB may receive an unexpected handover complete message from the target relay UE, for which it never performed handover preparation and has no UE context. Also, the target gNB that was expecting a handover complete message from the target relay UE will timeout due to non-receipt. However, the new gNB and the target gNB will not be prompted to perform any recovery action and the remote UE will remain unaware that the handover failed.

In another example, in a second path-switch scenario, when the target relay UE is in an idle/inactive state, a network node (for example, a source gNB) that serves the target relay UE may hold little or no information about the target relay UE prior to a path switch operation. Thus, it may be difficult for the source gNB to perform certain operations such as selecting one of several candidate target relay UEs, determining whether to admit a target relay UE to an RRC_CONNECTED mode of operation, or predicting the performance of an indirect path through the target relay UE.

Both of these scenarios pose challenges. This disclosure addresses those challenges. Both challenges are initially addressed during a discovery stage of an x2i path switch. In the first path-switch scenario, an objective is to provide awareness to the remote UE of a failed handover to be relayed by the target relay UE. The remote UE can only perform a recovery process from the failed handover if it is aware of the failure. However, the remote UE can be unaware of the handover failure when it occurs, due to cell reselection by the target relay UE from a target gNB to a new gNB while the handover is in process and while the target relay UE is in an idle/inactive state. This objective is achieved by the target relay UE recognizing, when it receives a reconfiguration complete message from the remote UE, that the handover of the remote UE is targeting a different gNB than the new gNB that is handling the current serving cell of the target relay UE.

In order for the target relay UE to recognize that the gNBs are different, the target relay UE remembers the original target gNB that served its cell at the time of discovery (and that is the target of the path switch from the perspective of the remote UE). Upon realizing that the source gNB and the new gNB are different, the target relay UE can respond to the reconfiguration complete message with a notification that the handover has failed. This way, the remote UE is aware of the failure and can take steps to initiate handling the failure.

In the second path-switch scenario, an objective is for the remote UE and the gNBs involved in the path switch to determine that the target relay UE is an acceptable or good target relay UE, which may be determined based on the remote UE's Uu radio conditions, or to determine whether the UE has certain capabilities. The Uu radio conditions and UE capabilities can be determined for a plurality of candidate target relay UEs. However, since the target relay UE is in an idle/inactive state, the target gNB does not know the target relay UE's Uu conditions or capabilities. Another objective is for the target gNB to be aware that it is admitting the target relay UE for a handover. These objectives are achieved by causing the remote UE to determine during discovery the target relay UE's Uu conditions and/or capabilities. The remote UE may report this information to the source gNB. The target gNB may perform handover admission by taking into account the Uu conditions of the target relay UE. In addition or alternatively, the gNB responsible for target selection for the handover may select a target relay UE from the candidate target relay UEs using the Uu condition of capability information of the respective candidate UEs.

FIG. 7 is a schematic diagram 700 illustrating an example of relay and remote UE operation. A base station of a communication system 700, such as a gNB 702, serves a first (relay) UE 710 over a first direct interface, such as a Uu interface 731. In turn, first UE 710 serves a second (remote) UE 712 over a second direct interface, such as the PC5 interface 733. PC5 interface 733 may also be referred to as a sidelink interface. Remote UE 712 is shown as being out of coverage of a cell 720 operated by gNB 702, but it should be appreciated that a relaying relationship may also exist for cases where remote UE 712 is in coverage. For example, remote UE 712 may be in poor coverage at the edge of cell 720, allowing remote UE 712 to receive better service through the combination of a good PC5 link 733 to relay UE 710 with relay UE 710's good Uu link 731 to gNB 702, which is better than remote UE 712's own poor Uu link (not shown) directly to gNB 702. Communications to and from remote UE 712 may be carried through relay UE 710 to and from gNB 702, allowing remote UE 712 to be served by the communication system 700 with good performance.

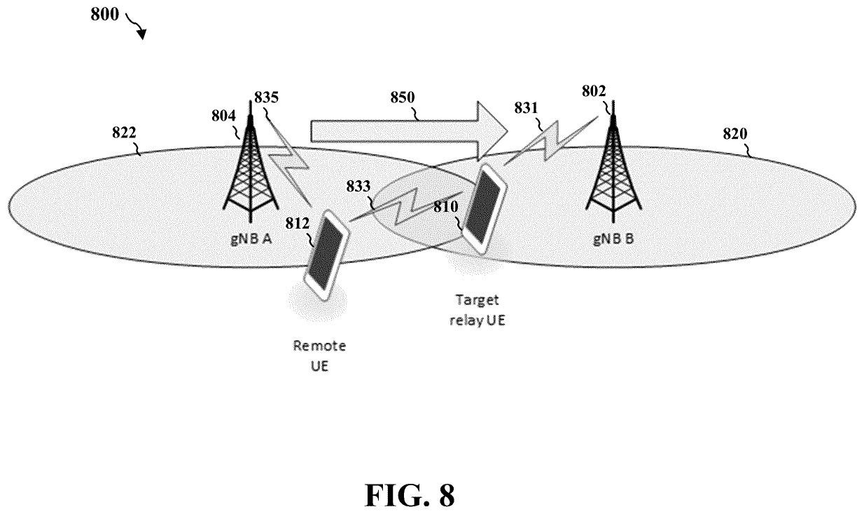

FIG. 8 is a schematic diagram of a communication system 800 illustrating an example path switch procedure from a first (source) gNB 804, where a remote UE 812 is in direct service to source gNB 804 via Uu link 835. A target relay UE 810 is in direct service to a second (target) gNB 802 via a Uu link 831. Target UE relay 810 serves remote UE 812 over a sidelink direct interface, such as the PC5 interface 833. Remote UE 812 is initially in the coverage of a source cell 822 of source gNB 804. Note that FIG. 8 suggests that remote UE 812 may be at an extreme edge of source cell 822; this situation is plausible as a prelude to mobility, since remote UE 812 may be handed over by a handover procedure indicated by arrow 850 due to moving out of coverage of source gNB 804, but it is not a necessary condition. In general, source gNB 804 may trigger a handover at any time based on criteria defined by its own implementation. In response to a decision by source gNB 804 to trigger a mobility procedure, remote UE 812 is transferred to indirect service with target gNB 802 through target relay UE 810. In the example shown, target gNB 802 serves a cell 820, and target relay UE 810 is within coverage of cell 820.

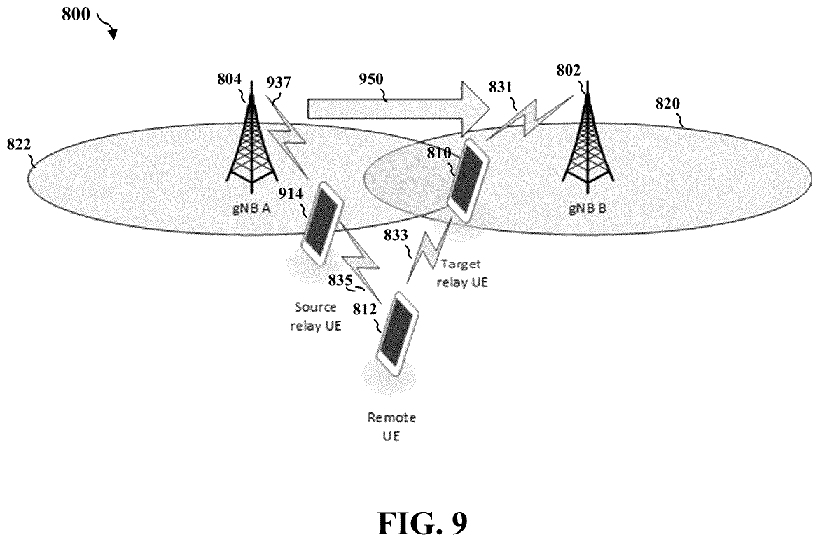

FIG. 9 is a schematic diagram of the communication system 800 illustrating a second example path switch procedure from source gNB 804, with which remote UE 812 is in indirect service via a source relay UE 914, to target gNB 802, where remote UE 812 is in indirect service via target relay UE 810. Remote UE 812 may be in the physical coverage of either cell 820 or 822, or out of coverage entirely (as shown in FIG. 9), but receives its service through source relay UE 914 and target relay UE 810. Remote UE 812 is initially served by source gNB 804 via source relay UE 914, and in response to a decision by source gNB 804 to trigger a mobility procedure, remote UE 812 is transferred to indirect service via target relay UE 810, which is served by target gNB 802.

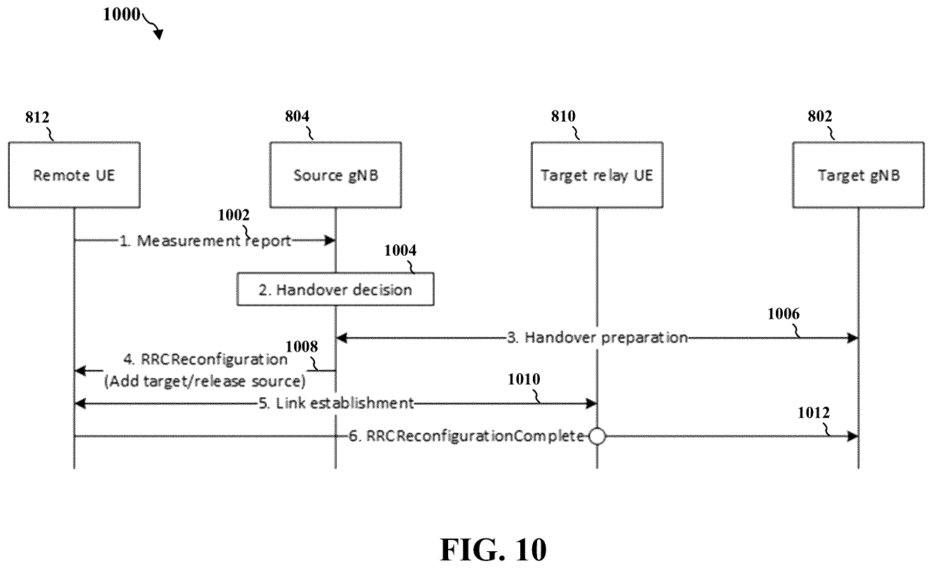

FIG. 10 shows a message flow 1000 for a direct-to-indirect path switch procedure, in which remote UE 812 is transferred from direct service with source gNB 804 to indirect service via target relay UE 810 with target gNB 802. At operation 1002, remote UE 812 sends to source gNB 804 a measurement report that may include, for example, measurements of target relay UE 810. It is noted that a discovery procedure between remote UE 812 and target relay UE 810 may precede operation 1002, allowing remote UE 812 to be aware that target relay UE 810 is available for or offering relay service. (This procedure is not shown in the figure.) At operation 1004, source gNB 804 determines to trigger a handover procedure or mobility procedure. In certain embodiments, the handover procedure is triggered in the form of a path switch to target relay UE 810. In certain embodiments, the handover procedure or mobility procedure is performed to induce remote UE 812 to switch its communication path. The handover decision may be in accordance with any criteria selected by source gNB 804 according to its implementation. For example, the handover decision may be informed by measurements of target relay UE 810 reported to source gNB 804 by remote UE 812.

At operation 1006, source gNB 804 and target gNB 802 perform a handover preparation procedure. The handover procedure can include an exchange of messages to confirm admission of remote UE 812 to receive service from target gNB 802 and to prepare target gNB 802 to receive remote UE 812 in handover. The exchange of messages can be on an inter-gNB interface such as an Xn interface. In certain embodiments, the handover preparation procedure may include delivery, to source gNB 804 from target gNB 802, of a handover command to be forwarded to remote UE 812. In certain embodiments, the handover preparation procedure may include determining, by target gNB 802 if remote UE 812 can be admitted to service with target gNB 802.

At operation 1008, source gNB 804 sends to remote UE 812 a reconfiguration message (for example, an RRCReconfiguration message of an RRC protocol). In certain embodiments, the reconfiguration message can include a forwarded version of the handover command from operation 1006, and may further include instructions to “add” (i.e., establish a connection with) target relay UE 810 and to release (i.e., release a connection with) and the source (source gNB 804 in the direct-to-indirect case, or the source relay UE in the indirect-to-indirect case). In certain embodiments, the reconfiguration message of operation 1008 can include a handover command received from target gNB 802 as part of the signaling at operation 1006.

At operation 1010, remote UE 812 and target relay UE 810 perform a procedure for link establishment, for example, using a PC5 interface. The PC5 interface establishment can include a PC5 unicast link establishment procedure and/or a PC5-RRC connection establishment procedure (similar to link 833 shown in FIG. 8). At operation 1012, remote UE 812 sends to target gNB 802, via target relay UE 810, a handover completion message (for example, an RRCReconfigurationComplete message of an RRC protocol), informing target gNB 802 that remote UE 812 is in its service and completing the handover procedure. The handover completion message indicates to target gNB 802 that remote UE 812 has performed its mobility procedure, allowing communication to proceed between target gNB 802 and remote UE 812 (via target relay UE 810). However, per the telecommunication standard used, the handover completion message may not identify a target cell of the handover (in this example, 820) or a gNB operating the target cell (in this example 802).

It should be appreciated that the flow of FIG. 10 is also substantially applicable to an indirect-to-indirect path switch procedure, in which remote UE 812 is transferred from indirect service via a source relay UE (not shown in FIG. 10, but similar to source relay UE 914 shown in FIG. 9) with source gNB 804 to indirect service via target relay UE 810 with target gNB 802. The difference from FIG. 10 in this case is that the measurement report of operation 1002 would be relayed to source gNB 804 via the source relay UE. In addition, the “add target/release source” procedures triggered by operation 1008 may include a release of a connection or unicast link between remote UE 812 and the source relay UE.

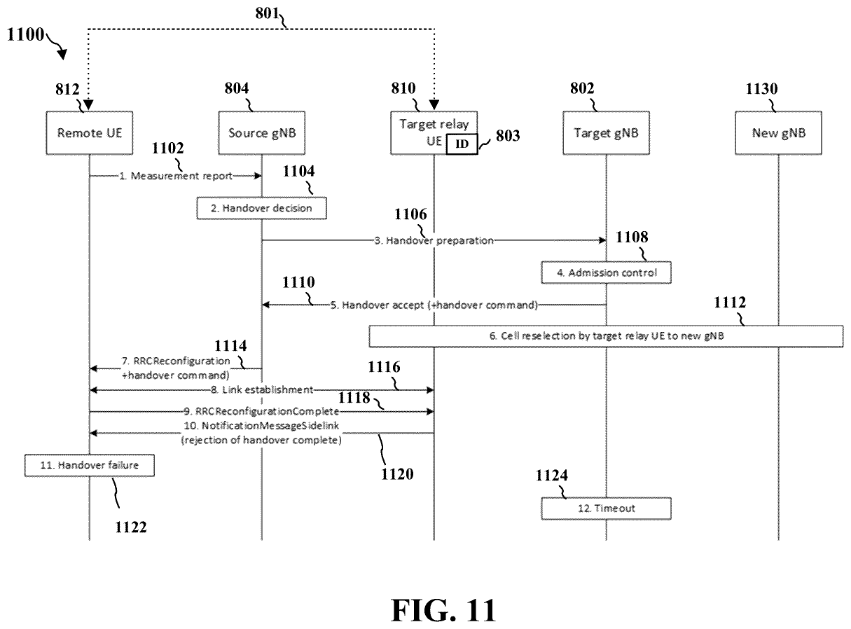

FIG. 11 shows a message flow for a direct-to-indirect path switch procedure in which target relay UE 810 is initially in an RRC_IDLE or RRC_INACTIVE protocol state, and in which target relay UE 810 reselects to a cell operated by a new gNB 1130 during the path switch, in accordance with one novel aspect. In this example, target relay UE 810 prevents delivery of the handover complete message to new gNB 1130, since new gNB 1130 is unprepared. Delivery of the handover complete message can be prevented by rejecting attempts by remote UE 812 to have the handover complete message forwarded. It is noted that FIG. 11 may also be applied, with minimal modifications, to an indirect-to-indirect path switch. The differences between the illustrated procedure and its analogue in the indirect-to-indirect setting are described below.

At operation 1102, remote UE 812 sends to source gNB 804 a measurement report, which may, for example, comprise measurements of target relay UE 810; this operation is similar to operation 1002 of FIG. 10. (In case of an indirect-to-indirect path switch, operation 1102 is relayed via a source relay UE (not shown in FIG. 11, but similar to source relay UE 914 shown in FIG. 9). At this stage, target relay UE 810 is assumed to be in an RRC_IDLE or RRC_INACTIVE state and served by target gNB 802. The identity of target gNB 802 may be indicated by target relay UE 810 to remote UE 812 during a discovery procedure 801. The measurement report may include an indication of the identity of target gNB 802, which can be used by source gNB 804 to determine which gNB it needs to communicate with.

In addition, at operation 803, target relay UE 810 can store for future use the identity (ID) of target gNB 802 or an identity of a cell operated by target gNB 802 that served target relay UE 810 at the time of discovery procedure 801 with remote UE 812.

At operation 1104, source gNB 804 makes a decision to trigger a path switch of remote UE 812 to target relay UE 810 via a handover procedure. This decision may be in accordance with any criteria embodied in implementation of source gNB 804; in some embodiments, the decision may be conditioned on a measurement event, which may be indicated in the measurement report received by source gNB 804 at operation 1102. For example, a measurement event indicated by the measurement report may include an indication that target relay UE 810's signal is better than a defined threshold; that target relay UE 810's signal is better than a first threshold and source gNB 804's signal is worse than a second threshold; or, in the indirect-to-indirect case (not shown in the figure), that target relay UE 810's signal is better than a source relay UE's signal by another defined threshold.

At operation 1106, source gNB 804 sends to target gNB 802 a handover preparation message. The handover preparation message may identify remote UE 812, describe a context and/or configuration of remote UE 812, and so on, in accordance with legacy handover procedures. The handover preparation message may identify target relay UE 810 and thus inform target gNB 802 that target relay UE 810 is in its service.

At operation 1108, target gNB 802 takes an admission control decision; that is, target gNB 802 determines whether to admit remote UE 812 and target relay UE 810 into service. Target gNB 802 may consider substantially any criteria in its admission control decision; in some embodiments, target gNB 802 may consider its current load of served UEs and/or served traffic flows and evaluate whether it has the capacity to admit the additional traffic required for remote UE 812 and/or target relay UE 810.

At operation 1110, having taken the decision to admit remote UE 812 and target relay UE 810 into service, target gNB 802 sends to source gNB 804 a handover accept message. The handover accept message may include a handover command formulated by target gNB 802 and intended to be delivered to remote UE 812. The handover command may include a configuration for remote UE 812 to apply for operation on an indirect path via target relay UE 810 in target gNB 802.

At operation 1112, target relay UE 810 performs a cell reselection procedure to a cell of new gNB 1130. Because target relay UE 810 is still in an RRC_IDLE or RRC_INACTIVE protocol state, its mobility is under the control of target relay UE 810 itself. Target relay UE 810's mobility procedures may, for example, be based on measuring downlink signals from a plurality of cells and reselecting to the “best” cell, i.e., the cell with the strongest or best-quality signal when considered in light of a set of cell reselection parameters. It is noted that the cell reselection event to operation 1112 may not be detectable by remote UE 812, target gNB 802, or new gNB 1130; only target relay UE 810 itself knows that it has moved to a new serving cell.

Although operation 1112 is shown immediately following operation 1110 in the FIG. 11, it should be appreciated that operation 1112 may occur at any time from operation 1102 to operation 1116. In other words, target relay UE 810 can be known to be served by target gNB 802 when it announces its serving cell ID in a discovery procedure (which may occur at any time before operation 1102), and at any time after the discovery procedure, target relay UE 810 may perform a cell reselection, unbeknownst to other entities in FIG. 11. If the cell reselection occurs before or simultaneously with operation 1116, target relay UE 810 will be unable to forward the handover completion message (which should occur at operation 1118) to target gNB 802 for which the handover completion message is intended. Furthermore, target relay UE 810's serving cell will not have changed during the lifetime of the unicast link established in operation 1116, so target relay UE 810 may not have a basis to notify remote UE 812 of the new serving cell. Thus, for a cell reselection occurring at any time up to and including operation 1116, remote UE 812 may be expected to be unaware of the resulting cell change of target relay UE 810.

At operation 1114, source gNB 804 sends to remote UE 812 a reconfiguration message (for example, an RRCReconfiguration message of an RRC protocol), which may contain the handover command from operation 1110. Operation 1114 includes delivery of the handover command to remote UE 812, resulting in remote UE 812 triggering a mobility procedure. The reconfiguration message may contain a configuration for remote UE 812 to communicate with target relay UE 810. In the indirect-to-indirect case, the reconfiguration message may contain an instruction for remote UE 812 to release a connection with a source relay UE (not shown in FIG. 11, but similar to source relay UE 914 shown in FIG. 9).

At operation 1116, remote UE 812 establishes a communication link (for instance, a PC5 unicast link and/or a PC5-RRC connection) with target relay UE 810. This communication link allows data, such as control signaling and/or user data, to be conveyed between remote UE 812 and target relay UE 810. At substantially the same time as operation 1116, in the indirect-to-indirect case, remote UE 812 may release a communication link with the source relay UE.

At operation 1118, remote UE 812 transmits to target relay UE 810 a handover completion message, e.g., an RRCReconfigurationComplete message of an RRC protocol. The handover completion message may be intended for forwarding to target gNB 802. However, target relay UE 810 is no longer served by target gNB 802, and target relay UE 810 may as a result be unable to forward the handover completion message to target gNB 802. Furthermore, if target relay UE 810 were to forward the handover completion message to new gNB 1130, new gNB 1130 would not be able to apply the message and complete the handover, since new gNB 1130 has not been informed of the context and/or configuration of remote UE 812 and has not had the opportunity to take an admission control decision for remote UE 812 and target relay UE 810. Thus, target relay UE 810 may not be able to assist remote UE 812 in completing the path switch procedure.

At operation 1120, target relay UE 810 sends to remote UE 812 a notification message (for example, a NotificationMessageSidelink message of a PC5-RRC protocol). The notification message may indicate that target relay UE 810's serving cell has changed between the discovery procedure and the reception of the handover completion message. The notification message may indicate that the handover completion message is rejected by target relay UE 810, i.e., that target relay UE 810 does not forward the handover completion message to any gNB.

Prior to sending the notification message, target relay UE 810 can determine that its serving cell has changed between the discovery procedure and the reception of the handover completion message. This determination can be performed by comparing the ID that was stored at operation 803 with an ID of the gNB or its cell that is now serving target relay UE 810. The cell identified by the stored ID is assumed by remote UE 812 to be currently serving target relay UE 810 and is intended by remote UE 812 to complete the handover. In the scenario shown in FIG. 11, the ID identifies target gNB 802 (or a cell operated by target gNB 802), which is different than new gNB 1130 (or its cell) that is currently serving target relay UE 810. Due to this mismatch, target relay UE 810 realizes that its serving cell has changed between the discovery procedure and the reception of the handover completion message, which prompts target relay UE 810 to send the notification message that the handover completion message is rejected.

At operation 1122, remote UE 812 determines, based on the notification message in operation 1120, that the handover procedure for its path switch operation has failed. This determination may induce various procedures for path switch failure handling, such as relay reselection, cell reselection, connection re-establishment, and so on. Remote UE 812's procedures for path switch failure handling may be aligned with the procedures for the expiration of a supervisory timer governing the path switch procedure, such as a timer T420 defined in an RRC protocol.

At operation 1124, target gNB 802 experiences a timeout based on its failure to receive the handover completion message from remote UE 812. After operation 1124, both remote UE 812 and target gNB 802 are aware that the path switch has failed.

It is noted that existing mechanisms for detecting the failure of a path switch operation may not apply to the case where a target relay UE performs cell reselection during the path switch procedure. As noted above, target relay UE 810 may not be prompted to notify remote UE 812 of the cell change, since the cell change did not occur during the lifetime of the unicast link between remote UE 812 and target relay UE 810. Moreover, since the handover completion message is successfully delivered to target relay UE 810 in operation 1118 of FIG. 11, a supervisory timer (for instance, T420) at remote UE 812 may be stopped with the assumption that the handover completion message has been delivered successfully.

In some cases, target relay UE 810 may be unable to operate as a relay after the cell change occurs. For example, if permission to operate as a relay UE is based on the serving cell's downlink signal strength on a Uu interface being within a range (e.g., below a maximum threshold and/or above a minimum threshold), target relay UE 810 may find that its downlink signal strength on the Uu interface with the new serving cell is outside the range, meaning that target relay UE 810 is no longer permitted to operate as a relay UE. As another example, the new serving cell may not support relay operation at all. In such cases, it is clear that target relay UE 810 cannot forward the handover completion message received from remote UE 812. Instead, target relay UE 810 may notify remote UE 812 of its inability to continue relay operation, for instance, in the notification message shown in operation 1120. As one example, a NotificationMessageSidelink message of a PC5-RRC protocol may contain a cause code or indication type, whose value may indicate cell reselection (in accordance with legacy signalling for indicating a cell reselection, e.g., a value “relayUE-CellReselection”) and/or an inability to operate as a relay UE (e.g., indicated by anew value of the cause code or indication type).

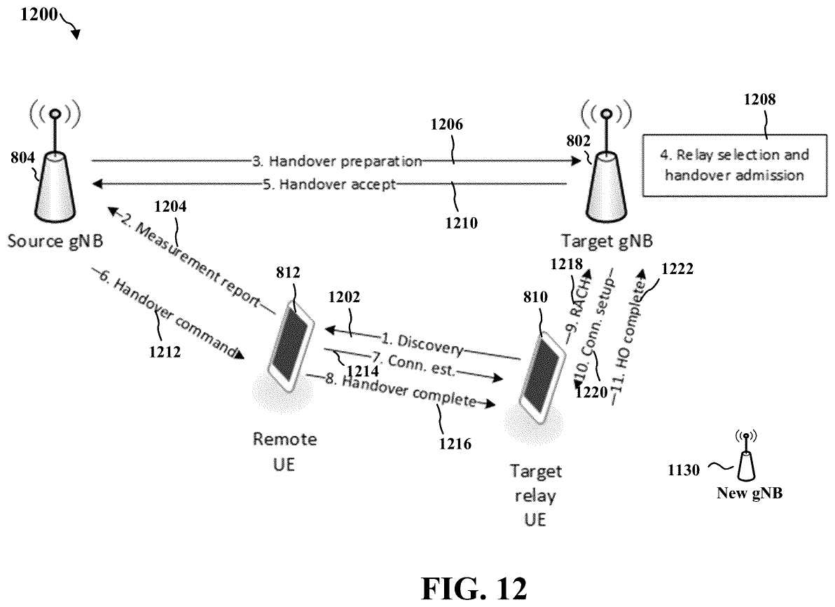

With reference to FIG. 12, an example is illustrated of a path switch procedure in which target relay UE 810 is initially in an idle/inactive state. A distinguishing characteristic of the idle/inactive protocol states is that target relay UE 810, while served by target gNB 802, does not have an active RRC connection with target gNB 802 and may not have a context stored at target gNB 802. (There is an exceptional case in which target relay UE 810 is in RRC_INACTIVE and target gNB 802 happens to be an anchor gNB for target relay UE 810. In such a case, target gNB 802 holds a partial context for target relay UE 810, but target relay UE 810 has no active RRC connection with any gNB, has no radio resources assigned for its use, and has no active communication with target gNB 802.) In case target relay UE 810 is in an idle/inactive state, target gNB 802 is not aware of radio conditions of target relay UE 810, and target gNB 802 may not know that it serves target relay UE 810 at all. Because of the lack of an RRC connection between target relay UE 810 and target gNB 802, target relay UE 810 must perform a state transition to an RRC_CONNECTED state before it can exchange relayed communications with target gNB 802 (for example, to forward signalling and/or traffic originating from remote UE 812).

At operation 1202, target relay UE 810 provides information to remote UE 812 as part of a discovery procedure. This operation is shown in isolation, as a communication from target relay UE 810 to remote UE 812, but it should be understood as part of a bidirectional discovery procedure whose other components are not shown in FIG. 12.

Various models of such a bidirectional discovery procedure can be employed. For example, target relay UE 810 may initiate discovery by advertising its availability as a relay UE (in accordance with operation 1202), whereupon remote UE 812 may respond to the advertisement to indicate its interest in relay service. Alternatively, remote UE 812 may initiate discovery by soliciting a relay service, whereupon target relay UE 810 may respond to the solicitation by indicating its availability as a relay UE (in accordance with operation 1202). For purposes of this discussion, either model of discovery may apply, but the information of interest for the path switch procedure is delivered in the discovery message from target relay UE 810 to remote UE 812 in operation 1202.

This discovery message may, for example, contain an indication of an observed or expected link quality of a Uu interface between target relay UE 810 and target gNB 802, or between target relay UE 810 and one cell hosted by target gNB 802. The indication may comprise a measure of radio quality, such as a reference signal received power (RSRP) or reference signal received quality (RSRQ) measurement. The indication may comprise a threshold of radio quality; for example, a measured RSRP and/or RSRQ value, or a filtered set of RSRP and/or RSRQ values, may be compared against a set of one or more thresholds to determine a level of radio quality that is less precise but potentially more stable than an individual “raw” RSRP or RSRQ value. The indication may comprise an anticipated level of performance or throughput available through the Uu interface, such as a nominal throughput level based on assumptions about the performance of the link as measured by target relay UE 810. The indication may be controlled by a specific defined measurement event, where some or all of a configured threshold, an offset, a hysteresis parameter, and/or a time-to-trigger parameter may apply. For example, when the reference signal received power (RSRP) measured by target relay UE 810 on the Uu interface is higher (or higher by an offset) than a configured threshold for an amount of time (e.g., a time to trigger), then the indication can be set up by target relay UE 810 within the discovery message.

Alternatively or additionally, the discovery message may comprise an indication of one or more communication capabilities of target relay UE 810, such as an indication or level of support for carrier aggregation (CA), multiple input/multiple output (MIMO) operation, and so on. Such an indication of communication capabilities may allow source gNB 804 or target gNB 802 to infer an expected performance of target relay UE 810; for example, target relay UE 810 supporting a higher MIMO rank may be preferred to one supporting a lower MIMO rank, since the higher MIMO rank may allow greater throughput on the Uu interface. Alternatively or additionally, the discovery message may comprise an indication of an RRC state of target relay UE 810, allowing the s source gNB 804 or target gNB 802 in subsequent operations to know if target relay UE 810 is in a particular RRC state.

In some embodiments, target gNB 802 may have the ability to configure maximum and/or minimum radio thresholds for operation as a relay UE. As a result, target relay UE 810 may be allowed to perform discovery only if, for instance, it measures the Uu interface above a minimum RSRP and below a maximum RSRP. The intention of a link quality indication in the discovery signalling is to provide a finer-grained measure of the anticipated performance of the Uu link, so that, for instance, source gNB 804 or target gNB 802 can compare a plurality of candidate relay UEs (all of which may meet the radio criteria for operation as a relay UE) and select as the target relay UE one of the plurality of candidate relay UEs based at least in part on the link quality.

At operation 1204, remote UE 812 transmits, to source gNB 804, a measurement report indicating information about target relay UE 810 acquired by remote UE 812 during discovery. The information in the measurement report can include a measured quantity of target relay UE 810. As one example, if remote UE 812 and target relay UE 810 communicate on a PC5 interface, the measurement report may indicate a PC5-RSRP value of signals received by remote UE 812 from target relay UE 810. The information in the measurement report can include, for example a serving cell ID of target relay UE 810, an identifier such as a layer 2 identifier (L2ID) of target relay UE 810, an indication of Uu link performance between target relay UE 810 and target gNB 802 (as described above), an indication of communication capabilities of target relay UE 810 (as described above), an indication of an RRC state of target relay UE 810 (as described above), and so on.

In some embodiments, remote UE 812 may discover and measure a plurality of candidate relay UEs. In this case, the measurement report may include information about a plurality of candidate relay UEs. Alternatively, operation 1204 may be expanded to comprise a plurality of measurement reports associated with different candidate relay UEs. In some embodiments, source gNB 804 may select a target relay UE from among the plurality of candidate relay UEs; in other embodiments, source gNB 804 may pass to target gNB 802 information on some or all of the plurality of candidate relay UEs, and target gNB 802 may select a target relay UE. Diverse criteria may be applied (e.g., by source gNB 804 or target gNB 802) to select a target relay UE; for example, source gNB 804 or target gNB 802 may prefer a target relay UE that is already in RRC_CONNECTED, a target relay UE with high communication capabilities, a target relay UE with a high-quality Uu link with target gNB 802, and so on.

At operation 1206, source gNB 804, having taken the decision to trigger a path switch procedure, sends a handover preparation message to target gNB 802. In case source gNB 804 has selected a target relay UE, the handover preparation message may comprise information specific to the selected target relay UE. On the other hand, in case target gNB 802 is responsible for selecting a target relay UE, the handover preparation message may comprise information related to a plurality of candidate relay UEs. In either case, the information related to the relay UE(s) may include information on the quality or anticipated performance of the Uu link, information on one or more communication capabilities, information on the RRC state(s) of the relay UE(s), identifiers such as L2IDs of the relay UEs, and so on. The handover preparation message may also comprise information related to the configuration and context of remote UE 812, allowing target gNB 802 to make an informed decision on whether it should admit remote UE 812 into service with target gNB 802.

At operation 1208, target gNB 802 selects a target relay UE if necessary and determines to admit remote UE 812 and target relay UE 810 into service with target gNB 802. Alternatively, target relay selection may be performed by source gNB 804 (not shown in FIG. 12), in which case target gNB 802 only needs to perform handover admission for remote UE 812 and target relay UE 810. The selection of a target relay UE may be based on implementation-dependent criteria, which may take into account any of the information provided in the measurement report (operation 1204) and/or the handover preparation message (operation 1206). The decision to admit the UEs as part of the handover procedure may be based on system load at target gNB 802, on information received by target gNB 802 at operation 1206 (for example, regarding the status of target relay UE 810), or on any other information available to target gNB 802's implementation.

At operation 1210, target gNB 802 sends to source gNB 804 a handover accept message. The handover accept message indicates that target gNB 802 has concluded that it can admit remote UE 812 and target relay UE 810 to service as part of the path switch procedure. If target gNB 802 selected target relay UE 810 (from candidate relay UEs) at operation 1208, the handover accept message may include an identifier (for instance, a L2ID) of selected target relay UE 810. The handover accept message may comprise a handover command formulated by target gNB 802 and including a configuration to be delivered to remote UE 812, in accordance with a handover procedure.

At operation 1212, source gNB 804 forwards the handover command to remote UE 812, for example, as part of an RRCReconfiguration message of an RRC protocol. The message containing the handover command may further contain one or more configuration instructions for remote UE 812; for example, the message containing the handover command may be an RRCReconfiguration message instructing remote UE 812 to establish a connection on a PC5 interface with target relay UE 810, to release an existing connection on a PC5 interface with a source relay UE (not shown in FIG. 12), and so on.

At operation 1214, remote UE 812 triggers a connection establishment procedure with target relay UE 810. In case remote UE 812 and target relay UE 810 communicate on a PC5 interface, the connection establishment procedure may comprise a PC5 unicast link establishment procedure, which may also result in the establishment of a PC5-RRC connection. In case remote UE 812 and target relay UE 810 communicate via a different interface, such as a Wi-Fi link or a proprietary technology, the connection establishment procedure may comprise any signalling necessary to establish a connection in the underlying technology. In some technologies, there may be no explicit connection establishment procedure, such as, for instance, technologies in which remote UE 812 and target relay UE 810 are preconfigured to operate together with prior knowledge of one another's identities, and in such a case operation 1214 may not occur.

At operation 1216, remote UE 812 delivers a handover complete message (for instance, an RRCReconfigurationComplete message of an RRC protocol) to target relay UE 810, with the expectation that the handover complete message will be forwarded to target gNB 802 to conclude the handover procedure. The handover complete message may be transmitted by remote UE 812 on radio resources configured as part of the connection establishment procedure at operation 1214, and/or on radio resources configured by a subsequent link reconfiguration procedure (although not shown in FIG. 12, this subsequent link reconfiguration procedure may, for instance, be triggered by an RRCReconfigurationSidelink message of a PC5-RRC protocol).

If target relay UE 810 were in an RRC_CONNECTED state, it would be expected to deliver the handover complete message to target gNB 802 directly. However, recalling that target relay UE 810 is initially in an RRC_IDLE or RRC_INACTIVE state, target relay UE 810 needs to establish or resume an RRC connection with target gNB 802 so that target relay UE 810 can deliver the handover complete message to target gNB 802. Accordingly, at operation 1218, target relay UE 810 triggers a random access channel (RACH) procedure to induce target gNB 802 to bring target relay UE 810 to an RRC_CONNECTED state. Various forms of the RACH procedure may be invoked in this operation, triggered, for example, by the transmission of an initial “Msg1” or “MsgA” signal from target relay UE 810 to target gNB 802.

At operation 1220, responsive to the triggering of the RACH procedure, target gNB 802 transmits, to target relay UE 810, a connection setup message (for example, an RRCSetup message if target relay UE 810 is initially in RRC_IDLE, or an RRCResume message if target relay UE 810 is initially in RRC_INACTIVE). The connection setup message may be transmitted, for example, as part of a “Msg3” or “MsgB” transmission of the RACH procedure that was initiated at operation 1218. The connection setup message may contain a configuration allowing relaying service to start. Alternatively, or additionally, target gNB 802 may transmit, to target relay UE 810, a reconfiguration message (not shown in FIG. 12) comprising a configuration allowing relaying service to start.

At operation 1222, target relay UE 810 transmits to target gNB 802 a forwarded version of the handover complete message from operation 1216. This message, when received at target gNB 802, concludes the handover procedure and allows communication between target gNB 802 and remote UE 812 via target relay UE 810.

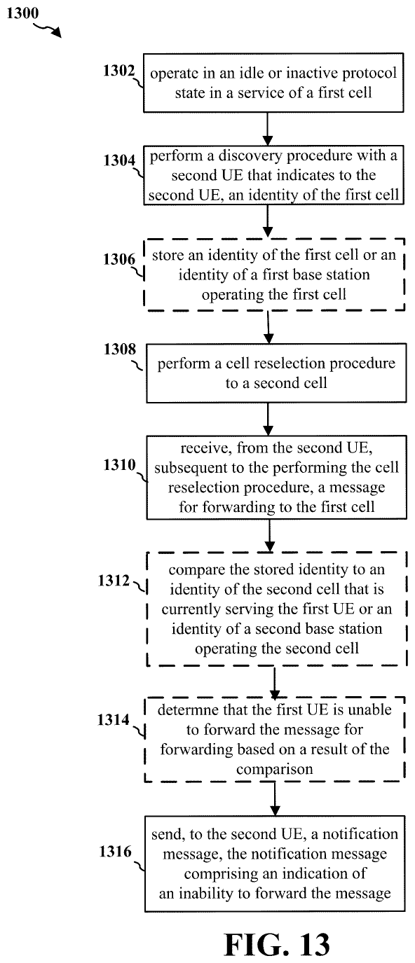

FIG. 13 is a flow chart 1300 of a method (process) for cell reselection handling. The method may be performed by a first UE (e.g., target relay UE 810 of FIG. 11). At operation 1302, the first UE operates in an idle or inactive protocol state in a service of a first cell. At operation 1304, the first UE performs, with a second UE (e.g., remote UE 812 of FIG. 11), a discovery procedure that indicates, to the second UE, an identity of the first cell. At optional operation 1306, the first UE stores an identity of the first cell or an identity of a first base station (e.g., target gNB 802 of FIG. 11) operating the first cell. At operation 1308, the first UE performs a cell reselection procedure to a second cell. At operation 1310, the first UE receives, from the second UE, subsequent to the performing the cell reselection procedure, a message for forwarding to the first cell. At optional operation 1312, the first UE compares the stored identity to an identity of the second cell that is currently serving the first UE or an identity of a second base station (e.g., new gNB 1130 of FIG. 11) operating the second cell. At optional operation 1314, the first UE determines that it is unable to forward the message for forwarding based on a result of the comparison. At operation 1316, the first UE sends, to the second UE, a notification message, the notification message comprising an indication of an inability to forward the message.

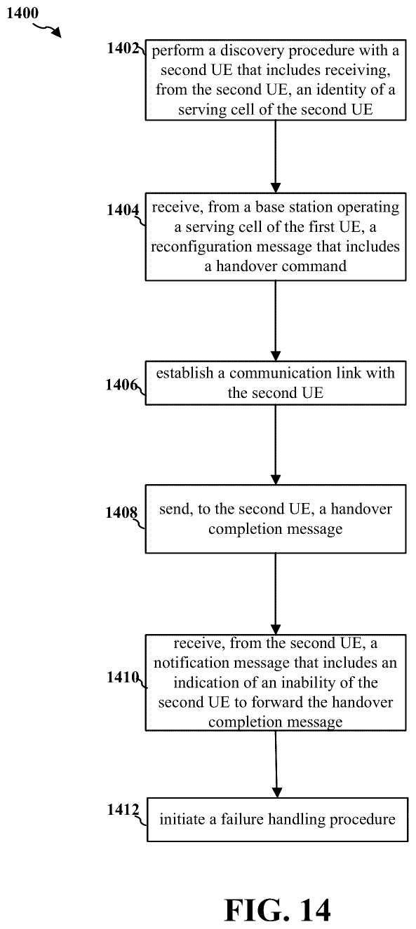

FIG. 14 is a flow chart 1400 of a method (process) for path switch control. The method may be performed by a first UE (e.g., remote UE 812 of FIG. 11). At operation 1302, the first UE performs a discovery procedure with a second UE (e.g., target relay UE 810 of FIG. 11). The discovery procedure includes receiving, from the second UE, an identity of a serving cell of the second UE. At operation 1404, the first UE receives, from a base station (e.g., source gNB 804 of FIG. 11) operating a serving cell of the first UE, a reconfiguration message, wherein the reconfiguration message includes a handover command. At operation 1406, the first UE establishes a communication link with the second UE. At operation 1408, the first UE sends, to the second UE, a handover completion message. At operation 1410, the first UE receives, from the second UE, a notification message, the notification message comprising an indication of an inability of the second UE to forward the handover completion message. At operation 1412, the first UE initiates a failure handling procedure.

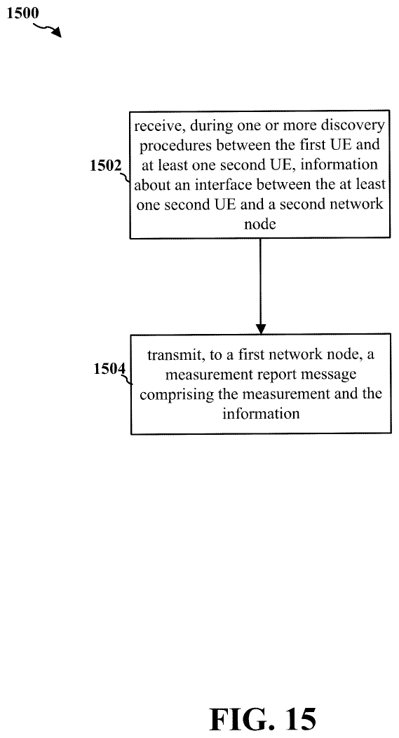

FIG. 15 is a flow chart 1500 of a method (process) for measurement reporting. The method may be performed by a first UE (e.g., remote UE 812 of FIG. 11). At operation 1502, the first UE receives, during one or more discovery procedures between the first UE and at least one second UE (e.g., target relay UE 810 of FIG. 11), information about an interface between the at least one second UE and a second network node. At operation 1504, the first UE transmits, to a first network node (e.g., source gNB 804 of FIG. 12), a measurement report message comprising the measurement and the information.

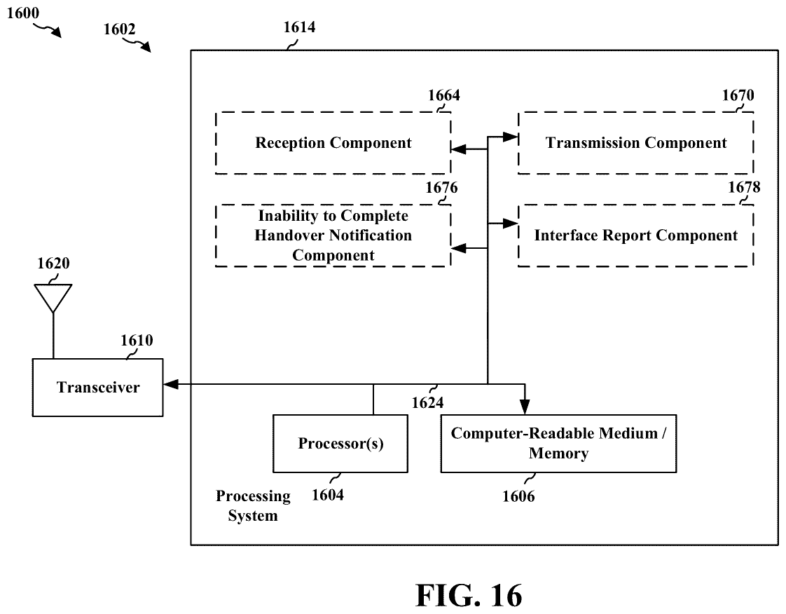

FIG. 16 is a diagram 1600 illustrating an example of a hardware implementation for an apparatus 1602 employing a processing system 1614. The apparatus 1602 may be a UE. The processing system 1614 may be implemented with a bus architecture, represented generally by a bus 1624. The bus 1624 may include any number of interconnecting buses and bridges depending on the specific application of the processing system 1614 and the overall design constraints. The bus 1624 links together various circuits including one or more processors and/or hardware components, represented by one or more processors 1604, a reception component 1664, a transmission component 1670, an inability to complete handover notification component 1676, an interface report component 1678, and a computer-readable medium/memory 1606. The bus 1624 may also link various other circuits such as timing sources, peripherals, voltage regulators, and power management circuits, etc.

The processing system 1614 may be coupled to a transceiver 1610, which may be one or more of the transceivers 254. The transceiver 1610 is coupled to one or more antennas 1620, which may be the communication antennas 252.

The transceiver 1610 provides a means for communicating with various other apparatus over a transmission medium. The transceiver 1610 receives a signal from the one or more antennas 1620, extracts information from the received signal, and provides the extracted information to the processing system 1614, specifically the reception component 1664. In addition, the transceiver 1610 receives information from the processing system 1614, specifically the transmission component 1670, and based on the received information, generates a signal to be applied to the one or more antennas 1620.

The processing system 1614 includes one or more processors 1604 coupled to a computer-readable medium/memory 1606. The one or more processors 1604 are responsible for general processing, including the execution of software stored on the computer-readable medium/memory 1606. The software, when executed by the one or more processors 1604, causes the processing system 1614 to perform the various functions described supra for any particular apparatus. The computer-readable medium/memory 1606 may also be used for storing data that is manipulated by the one or more processors 1604 when executing software. The processing system 1614 further includes at least one of the reception component 1664, the transmission component 1670, and at least one of the inability to complete handover notification component 1676 and the interface report component 1678. The components may be software components running in the one or more processors 1604, resident/stored in the computer readable medium/memory 1606, one or more hardware components coupled to the one or more processors 1604, or some combination thereof. The processing system 1614 may be a component of the UE 250 and may include the memory 260 and/or at least one of the TX processor 268, the RX processor 256, and the communication processor 259.

In one configuration, the apparatus 1602 for wireless communication includes means for performing each of the operations performed by either of the target relay UE in at least one of FIG. 11, FIG. 12, and FIG. 13 or the remote UE in at least one of FIGS. 11, FIG. 12, FIG. 14, and FIG. 15. The aforementioned means may be one or more of the aforementioned components of the apparatus 1602 and/or the processing system 1614 of the apparatus 1602 configured to perform the functions recited by the aforementioned means.

As described supra, the processing system 1614 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

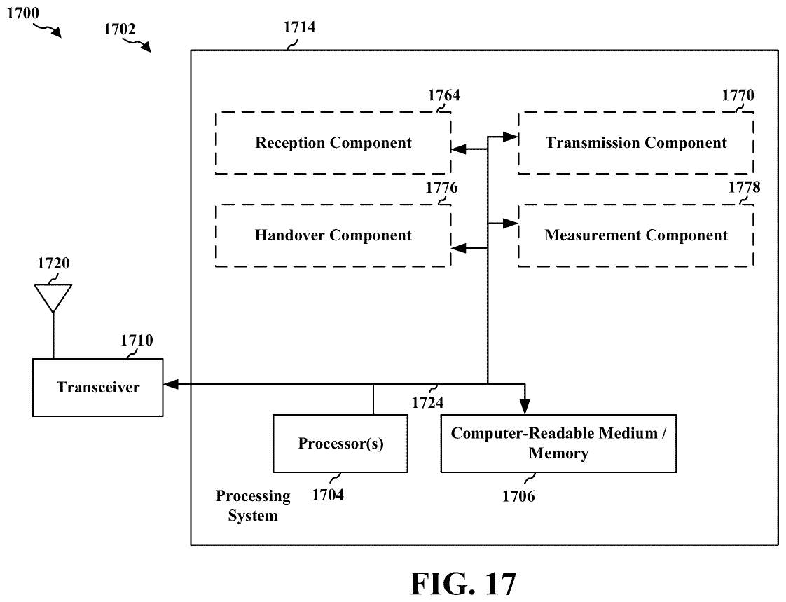

FIG. 17 is a diagram 1700 illustrating an example of a hardware implementation for an apparatus 1702 employing a processing system 1714. The apparatus 1702 may be a base station. The processing system 1714 may be implemented with a bus architecture, represented generally by a bus 1724. The bus 1724 may include any number of interconnecting buses and bridges depending on the specific application of the processing system 1714 and the overall design constraints. The bus 1724 links together various circuits including one or more processors and/or hardware components, represented by one or more processors 1704, a reception component 1764, a transmission component 1770, a handover component 1776 and measurement component 1778, and a computer-readable medium/memory 1706. The bus 1724 may also link various other circuits such as timing sources, peripherals, voltage regulators, and power management circuits, etc.

The processing system 1714 may be coupled to a transceiver 1710, which may be one or more of the transceivers 254. The transceiver 1710 is coupled to one or more antennas 1720, which may be the communication antennas 220.

The transceiver 1710 provides a means for communicating with various other apparatus over a transmission medium. The transceiver 1710 receives a signal from the one or more antennas 1720, extracts information from the received signal, and provides the extracted information to the processing system 1714, specifically the reception component 1764. In addition, the transceiver 1710 receives information from the processing system 1714, specifically the transmission component 1770, and based on the received information, generates a signal to be applied to the one or more antennas 1720.

The processing system 1714 includes one or more processors 1704 coupled to a computer-readable medium/memory 1706. The one or more processors 1704 are responsible for general processing, including the execution of software stored on the computer-readable medium/memory 1706. The software, when executed by the one or more processors 1704, causes the processing system 1714 to perform the various functions described supra for any particular apparatus. The computer-readable medium/memory 1706 may also be used for storing data that is manipulated by the one or more processors 1704 when executing software. The processing system 1714 further includes at least one of the reception component 1764, the transmission component 1770, the handover component 1776, and the measurement component 1778. The components may be software components running in the one or more processors 1704, resident/stored in the computer readable medium/memory 1706, one or more hardware components coupled to the one or more processors 1704, or some combination thereof. The processing system 1714 may be a component of the base station 210 and may include the memory 276 and/or at least one of the TX processor 216, the RX processor 270, and the controller/processor 275.

In one configuration, the apparatus 1702 for wireless communication includes means for performing each of the operations of either of gNB 802 and source gNB 804 in at least one of FIGS. 11 and 12. The aforementioned means may be one or more of the aforementioned components of the apparatus 1702 and/or the processing system 1714 of the apparatus 1702 configured to perform the functions recited by the aforementioned means.

As described supra, the processing system 1714 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of cell reselection handling operable in a first user equipment (UE), comprising:
operating in an idle or inactive protocol state in a service of a first cell;
performing a discovery procedure with a second UE, the discovery procedure comprising indicating, to the second UE, an identity of the first cell;
performing a cell reselection procedure to a second cell;
receiving, from the second UE, subsequent to the performing the cell reselection procedure, a message for forwarding to the first cell; and
sending, to the second UE, a notification message, the notification message comprising an indication of an inability to forward the message.

2. The method of claim 1, wherein the first cell is operated by a first base station and the second cell is operated by a second base station, the first base station and the second base station being different.

3. The method of claim 1, wherein the notification message comprises an indication that the first UE has performed a cell reselection.

4. The method of claim 1, wherein the notification message comprises an indication that the first UE cannot operate as a relay UE in the second cell.

5. The method of claim 1, wherein the message for forwarding to the first cell is a handover completion message for completing a handover, wherein the handover completion message is intended to be forwarded to the first cell, wherein the method further comprises:
storing, at the time of the discovery procedure, an identity of the first cell or an identity of a first base station operating the first cell;
comparing, at the time of receiving the message for forwarding, the stored identity to an identity of the second cell that is currently serving the first UE or an identity of a second base station operating the second cell; and
determining that the first UE is unable to forward the message for forwarding based on a result of the comparison.

6. A method of path switch control operable in a first user equipment (UE), comprising:
performing a discovery procedure with a second UE, the discovery procedure comprising receiving, from the second UE, an identity of a serving cell of the second UE;
receiving, from a base station operating a serving cell of the first UE, a reconfiguration message, the reconfiguration message comprising a handover command;
establishing a communication link with the second UE;
sending, to the second UE, a handover completion message;
receiving, from the second UE, a notification message, the notification message comprising an indication of an inability of the second UE to forward the handover completion message; and
initiating a failure handling procedure.

7. The method of claim 6, wherein the receiving the reconfiguration message comprises receiving, from a third UE served by the base station, the reconfiguration message.

8. The method of claim 6, wherein the notification message comprises an indication that the second UE has performed a cell reselection.

9. The method of claim 6, wherein the notification message comprises an indication that the second UE cannot operate as a relay UE in a cell that is currently serving the second UE.

10. The method of claim 6, wherein the failure handling procedure comprises one or more of a relay reselection procedure, a cell reselection procedure, and a connection re-establishment procedure.

11. A method of measurement reporting, operable at a first user equipment (UE) and comprising:
receiving, during one or more discovery procedures between the first UE and at least one second UE, information about an interface between the at least one second UE and a second network node; and
transmitting, to a first network node, a measurement report message comprising the measurement and the information.

12. The method of claim 11, wherein the information comprises an indication of radio quality on the interface.

13. The method of claim 12, wherein the indication is a measurement of at least one of reference signal received power (RSRP) and reference signal received quality (RSRQ).

14. The method of claim 12, wherein the indication is a threshold of link quality.

15. The method of claim 12, wherein the indication is a measure of anticipated link performance.

16. The method of claim 11, wherein the information comprises an indication of at least one supported communication capability on the interface.

17. The method of claim 16, wherein the capability is at least one of a supported CA capability and a supported MIMO capability.

18. The method of claim 11, wherein the information comprises an indication of a protocol state in which the first UE operates on the interface.

19. The method of claim 11, wherein during the discovery procedure, the at least one second UE is operating in an idle or inactive protocol state in a service of a cell established by the second network node.

20. The method of claim 11, wherein the measurement report message is transmitted in preparation for a handover procedure between the first network node and the second network node for one of the at least one second UEs to function as a relay UE for the first UE to allow the second network node to service the first UE.
